(19) United States
(12) Patent Application Publication
(10) Pub. No.: US 2025/0069392 A1
(43) Pub. Date: Feb. 27, 2025

(54) METHOD AND APPARATUS FOR SEARCHING FOR SAME OBJECT BASED ON MULTI-CAMERA IMAGE

(71) Applicant: Quantumeye Inc., Daejeon (KR)

(72) Inventors: Bum Suk CHOI, Daejeon (KR); Ye Bin YUN, Daejeon (KR)

(73) Assignee: Quantumeye Inc., Daejeon (KR)

(21) Appl. No.: 18/810,455

(22) Filed: Aug. 20, 2024

(30) Foreign Application Priority Data
Aug. 21, 2023 (KR) 10-2023-0109222

(51) Int. Cl. G06V 20/30; G06F 16/532; G06F 16/535; G06F 16/55; G06V 10/74; G06V 10/762; G06V 20/40

(52) U.S. Cl. CPC G06V 20/30; G06F 16/532; G06F 16/535; G06F 16/55; G06V 10/761; G06V 10/762; G06V 20/40

(57) ABSTRACT

Proposed is a method and apparatus for searching for the same object based on multi-camera images, the apparatus and method recognizing objects recorded from different directions through multiple cameras as the same object. An apparatus for searching for the same object based on multi-camera images that is operated by an object search model in accordance with an instruction from a controller is also proposed. A computer-readable recording medium on which a program for performing the method is recorded is also proposed.

### CROSS REFERENCE TO RELATED APPLICATION

The present application claims priority to Korean Patent Applications No. 10-2023-0109222, filed Aug. 21, 2023, the entire contents of which are incorporated herein for all purposes by this reference.

### BACKGROUND

### Technical Field

The present disclosure relates to a method and apparatus for searching for the same object and, in more detail, a method and apparatus for searching for the same object in videos or images obtained through multiple cameras or searching for the same object moving in different directions in videos or images obtained through one camera.

### Description of the Related Art

Object tracking is a technology of tracking detecting objects moving in a video and tracking movement of the objects. That is, it may mean a process of tracking the location of objects in a video having continuous frames rather than one image.

Fundamentally, object tracking can be performed through a method of detecting an object in one frame and searching for an object with features similar to the previously detected object in another frame. The features may be expressed as feature values having information such as the shape, line, size, etc. of an object in a frame.

Object tracking is used in various fields such as video surveillance systems, video calls, traffic control, augmented reality, sports, etc.

In particular, the importance of object tracking technology in a video surveillance system using cameras such as CCTVs is increasing for the safety of citizens such as crime prevention through CCTVs and searching for missing persons. In this case, object tracking can be used to determine the movement paths of people or objects collected by cameras.

In relation to this, a “SYSTEM AND METHOD FOR TRACKING OBJECTS USING CCTV” has been disclosed in Korean Patent Application Publication No. 10-2023-0099239. The patent discloses a process of finding an object through a second camera when the object disappears from a first camera.

The patent has a problem that when an object with a dissimilar front and back is tracked and the object disappears from a first camera that records the back, a second camera cannot search for the disappeared object and recognizes the object as a new object.

Accordingly, there is a need for a method that can recognize an object with a dissimilar front and back as the same object to overcome the problem described above.

### RELATED ART DOCUMENT

### Patent Document

(Patent Document 1) Korean Patent Application Publication No. 10-2023-0099239

### SUMMARY

In order to solve the problems described above, an objective of the present disclosure is to provide a method and apparatus for searching for the same object based on multi-camera images, the method and apparatus recognizing the same object recorded from different directions by multiple cameras.

Another objective of the present disclosure is to provide a method and apparatus for searching for the same object based on multi-camera images, the method and apparatus preventing an object from being recognized as an another object due to differences of figure, color, shape, etc. depending on recording directions.

In order to achieve the objectives described above, a method of searching for the same object based on multi-camera images according to an embodiment of the present disclosure is a method of searching for the same object based on multi-camera images by using gallery images obtained through multiple cameras, the method including: an obtaining step of obtaining a query image; a comparing step of determining similarity by comparing the query image with the gallery images; a ranking step of obtaining some of the gallery images as rank images on the basis of the similarity; and a rank recommendation step of obtaining at least one of the rank images as a recommendation image, wherein the method may repeatedly perform the comparing step, the ranking step, and the rank recommendation step using the at least one recommendation image as the query image.

Further, in an embodiment of the present disclosure, the comparing step may include: a calculation step of obtaining distance values between a feature value of a query image and feature values of the gallery images; and a determination step of obtaining similarity of the gallery images on the basis of the distance values.

Further, in an embodiment of the present disclosure, the ranking step may include obtaining the rank images in order of high similarity.

Further, in an embodiment of the present disclosure, the rank recommendation step may include: providing the rank images to a user; and obtaining at least one of the rank images selected by the user as the recommendation image.

Further, in an embodiment of the present disclosure, the query image in the comparing step and the recommendation image in the rank recommendation step may be images of the same object recorded through different cameras or recorded from different directions through one camera.

Meanwhile, a method of searching for the same object based on multi-camera images according to an embodiment of the present disclosure is a method of searching for the same object based on multi-camera images by using gallery images obtained through multiple cameras, the method including: an obtaining step of obtaining a query image; a comparing step of determining similarity by comparing the query image with the gallery images; a clustering step of clustering the gallery images on the basis of the similarity; and a cluster recommendation step of obtaining k pieces from the clustered gallery images as recommendation images, wherein the method may repeatedly perform the comparing step, the clustering step, and the cluster recommendation step using the k recommendation images as the query images.

Further, in an embodiment of the present disclosure, the cluster recommendation step may include: filtering out the clustered gallery images in accordance with preset conditions; and obtaining k pieces from the filtered gallery images as recommendation images.

Further, in an embodiment of the present disclosure, the preset conditions may include a first condition in which distance values between a feature value of the query image and feature values of the gallery images are larger than a minimum threshold.

Further, in an embodiment of the present disclosure, the preset conditions may include a second condition in which the distance values are smaller than a maximum threshold.

Further, in an embodiment of the present disclosure, the obtaining of k pieces as recommendation images may obtain the k pieces as the recommendation images from the filtered gallery images in order of small distance value between a feature value of the query image and feature values of the gallery images.

Meanwhile, an apparatus for searching for the same object based on multi-camera images according to an embodiment of the present disclosure is an apparatus for searching for the same object based on multi-camera images that is operated by an object search model in accordance with an instruction from a controller, wherein the object search model performs an obtaining step of obtaining a query image, a comparing step of determining similarity by comparing the query image with the gallery images, a ranking step of obtaining some of the gallery images as rank images on the basis of the similarity, and a rank recommendation step of obtaining at least one of the rank images as a recommendation image, and repeatedly performs the comparing step, the ranking step, and the rank recommendation step using the at least one recommendation image as the query image.

Meanwhile, a program for performing the method of searching for the same object based on multi-camera images is recorded on a computer-readable recording medium according to an embodiment of the present disclosure.

The present disclosure can search for the same object on the basis of images obtained by recording an object having different figures on the front and the back at various angles.

The present disclosure can search for images of the same object having different figures on the sides and the back.

### BRIEF DESCRIPTION OF THE DRAWINGS

FIG. 1 is a diagram showing the state when videos have been provided from multiple cameras in an apparatus for searching for the same object based on multi-camera images according to an embodiment of the present disclosure;

FIG. 2 is a block diagram showing the apparatus for searching for the same object based on multi-camera images according to an embodiment of the present disclosure;

FIG. 3A and FIG. 3B are diagrams showing examples of objects with different front and back images;

FIG. 4 is a diagram showing a method of searching for the same object based on multi-camera images according to an embodiment of the present disclosure;

FIG. 5 is a flowchart of a method of searching for the same object based on multi-camera images according to an embodiment of the present disclosure;

FIG. 6 is a diagram showing a method of searching for the same object based on multi-camera images according to an embodiment of the present disclosure;

FIG. 7 is a flowchart of a method of searching for the same object based on multi-camera images according to an embodiment of the present disclosure;

FIG. 8A is a diagram showing a first query image in an embodiment of the present disclosure;

FIG. 8B is a diagram showing a first query image and gallery images similar to the first query image in an embodiment of the present disclosure;

FIG. 8C is a diagram showing a second query image and gallery images similar to the second query image in an embodiment of the present disclosure;

FIG. 8D is a diagram showing a third query image and gallery images similar to the third query image in an embodiment of the present disclosure;

FIG. 9 is a diagram showing two recommendation images and two query images in an embodiment of the present disclosure; and

FIG. 10A to FIG. 10D are diagrams showing selectable next images in an embodiment of the present disclosure.

### BRIEF DESCRIPTION OF THE DRAWINGS

Those skilled in the art can implement the principle of the present disclosure and can develop various apparatuses included in the concept and range of the present disclosure which are not clearly described or shown herein though. All conditional terminologies and embodiments described herein should be understood as being definitely intended as an object for understanding the concept of the present disclosure without limiting the specifically stated embodiments and states.

The objectives, features, and advantages of the present disclosure described above will be clearer through the following detailed description relating to the accompanying drawing, so the spirit of the present disclosure would be easily implemented by those skilled in the art.

Embodiments described in the specification will be explained with reference to cross-sectional views and/or perspective views that are ideal exemplary views of the present disclosure. The thicknesses, etc. of films and regions shown in the drawings are exaggerated for effective description of the present disclosure. The shapes of the exemplary views may be deformed by manufacturing technologies and/or tolerances. Accordingly, embodiments of the present disclosure are not limited to the specific types shown in the drawings and include variation of the types, depending on the manufacturing processes.

In the description of various embodiments, same names and same reference numerals are given to components having same functions for the convenience even through the embodiments are different. Further, the expression ‘at least one of A, B, and C’ means being composed of one, two, or three of A, B, and C. Further, the expression ‘provide’ is a concept including the meaning of providing the subject to a user through an output device through one device and meaning of providing the subject from one device to another device. Further, configurations and operations described already in other embodiments are omitted for the convenience.

Hereafter, a method of searching for the same object based on multi-camera images (hereafter, referred to as a ‘same object search method’) according to an embodiment of the present disclosure and an apparatus 100 for searching for the same object based on multi-camera images, (hereafter, referred to as a ‘same object search apparatus’) according to an embodiment of the present disclosure are described.

First, the same object search apparatus 100 is described.

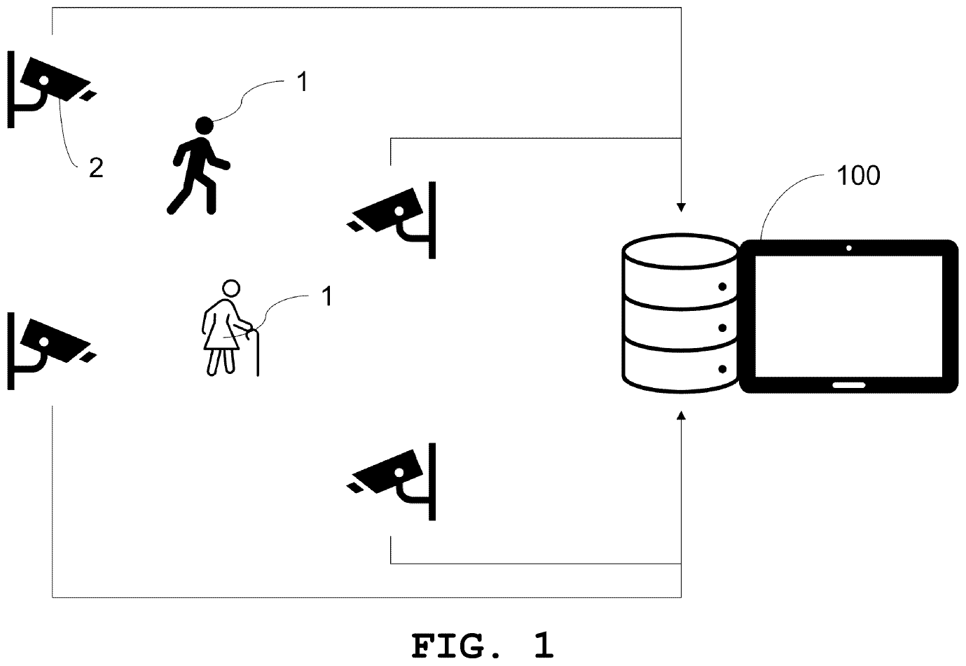

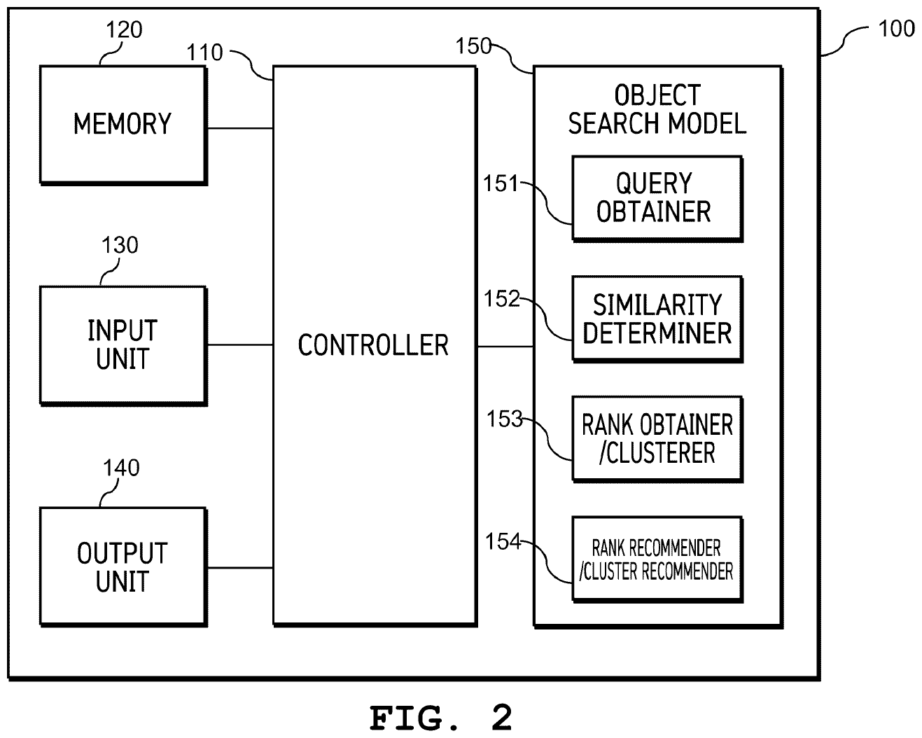

FIG. 1 is a diagram showing the state when videos have been provided from multiple cameras 2 in an apparatus 100 for searching for the same object based on multi-camera images according to an embodiment of the present disclosure. FIG. 2 is a block diagram showing the apparatus 100 for searching for the same object based on multi-camera images according to an embodiment of the present disclosure.

Referring to FIG. 1 and FIG. 2, the same object search apparatus 100 may include a controller 110, a memory 120, an input unit 130, an output unit 140, and an object search model 150. These components are not all necessary components of the same object search apparatus 100, and the same object search apparatus 100 may be implemented by fewer components or more components.

The controller 110 may mean a device that processes signals and controls components. That is, the controller 110 can process data input from the input unit 130, data to be output to the output unit 140, and data stored in the memory 120. That is, the controller 110 can serve as a processor. The controller 110 can instruct the object search model 150 to perform the steps of the same object search method.

The memory 120 can store programs for processing, controlling, etc. of the controller 110. Further, the memory 120 can temporarily store data input from the input unit 130, data output to the output unit 140, etc. A least one or more memories 120 may be provided in the same object search apparatus 100.

The memory 120 may include at least one type of storage medium of a flash memory, a hard disk drive (HDD), a solid state drive (SSD), a multimedia card micro type, a card-type memory (e.g., SD or XD), a RAM, a ROM, a magnetic memory, a magnetic disc, and an optical disc.

The memory 120 can store video data obtained from one or multiple cameras 2. The memory 120 can store frame images segmented by frame from video data obtained from one or multiple cameras 2.

A computer-readable recording medium according to an embodiment of the present disclosure can store a program for performing the same object search method. The recording medium may include at least one of the memories 120.

The input unit 130, which is a component for inputting matters to be processed by the controller 110 or to be stored in the memory 120, may be at least one of a keyboard, a mouse, a microphone, and a touch screen, but is not limited thereto. The input unit 130 can be used as a component for selecting at least one recommendation image 40 from rank images 30. The input unit 130 can be used as a component for selecting k recommendation images 40 from clustered gallery images 21.

The output unit 140, which is a component for outputting matters processed by the controller 110 or stored in the memory 120, may be at least one of a display, a speaker, and a vibrator, but is not limited thereto. The output image 140 can provide a user with at least one of a query image 10, gallery images 20, rank images 30, and a recommendation image 40.

The object search model 150 may be configured and stored as data in the memory 120 and the controller 110 can operate the object search model 150 in accordance with an order or an instruction.

The same object search apparatus 100 may include an object search model 150. As an embodiment, the object search model 150 may include a query obtainer 151, a similarity determiner 152, a rank obtainer 153, and a rank recommender 154. As an embodiment, the object search model 150 may include a query obtainer 151, a similarity determiner 152, a clusterer 153, and a cluster recommender 154. These components are not necessary components of the object search model 150 and the object search model 150 may include more or less components.

The same object search apparatus 100 may be configured as at least one of a smartphone, a tablet, a PC, and a server, but is not limited thereto. That is, the same object search apparatus 100 may be an electronic device including the controller 110 and the memory 120.

The same object search apparatus 100 can perform the same object search method. The same object search may include all of the matters to be described below.

Next, the same object search method is described.

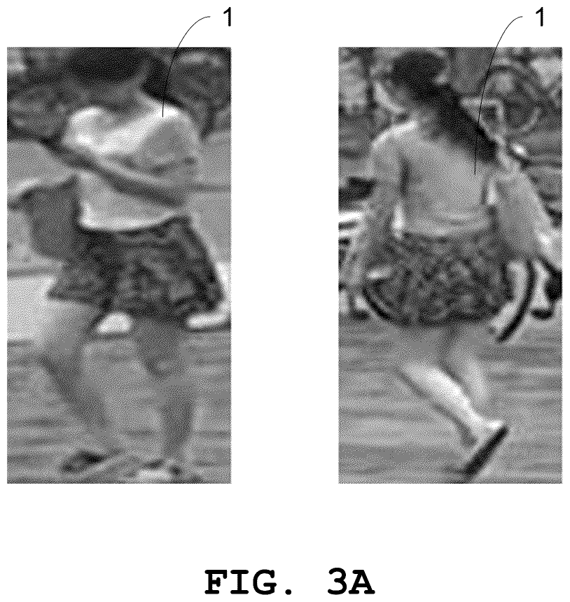

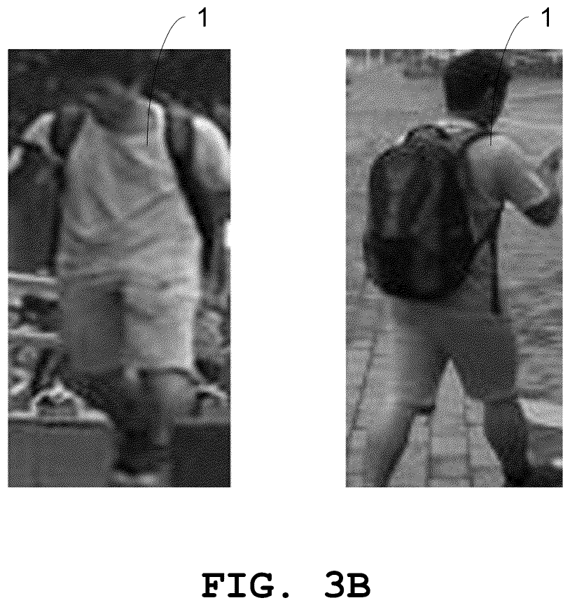

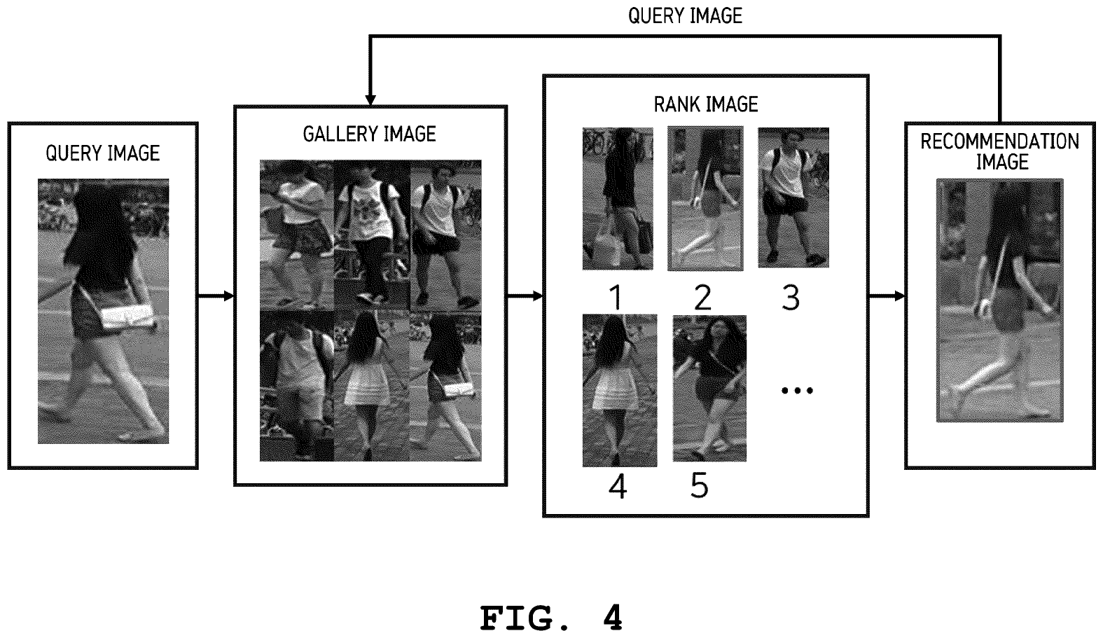

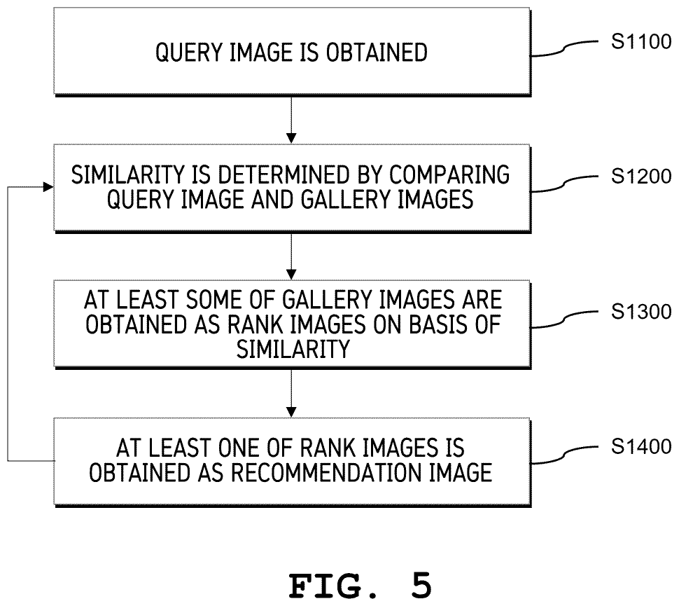

FIG. 3A and FIG. 3B are diagrams showing examples of objects 1 with different front and back images. FIG. 4 is a diagram showing a method of searching for the same object based on multi-camera images according to an embodiment of the present disclosure. FIG. 5 is a flowchart of a method of searching for the same object based on multi-camera images according to an embodiment of the present disclosure.

Referring to FIG. 3A and FIG. 3B, there may be a state corresponding to the same object 1 and having different front and back. The object 1 may have different shapes or colors on the front and back. For example, when the object 1 is a car, the front, sides, and rear of the object 1 all may have different shapes. When the object 1 is a person, the clothes of the person may have different colors on the front and back, and the front and back may have different shapes, depending on the clothes or accessories (e.g., a bag) that the object 1 wears.

The same object search method according to an embodiment of the present disclosure, as shown in FIG. 3A and FIG. 3B, can search for the same object 1 by repeatedly applying a query image 10 even though images are recognized as different images due to different recording directions of multiple cameras 2 or even though images are recognized as different images due to different recording angles even if the images are taken by one camera 2.

Referring to FIG. 4 and FIG. 5, in an embodiment, the same object search method can use gallery images 20 obtained through multiple cameras 2 or one camera 2. The same object search method may include: an obtaining step of obtaining a query image 10 (S1100); a comparing step of determining similarity by comparing the query image 10 with gallery images 20 (S1200); a ranking step of obtaining some of the gallery images as rank images 30 on the basis of the similarity (S1300); and a rank recommendation step of obtaining at least one of the rank images 30 as a recommendation image 40 (S1400). The same object search method can repeatedly perform the comparing step (S1200), the ranking step (S1300), and the rank recommendation step (S1400) using at least one recommendation image 40 as a query image 10.

First, the obtaining step (S1100) of obtaining a query image 10 may be performed.

The obtaining step (S1100) may be performed in accordance with an instruction from the controller 110 and may be performed by the query obtainer 151 of the object search model 150. Since the obtaining step (S1100) can be repeatedly performed, in some of the present specification, a query image 10 may be described as a first query image 11 in first round, a query image 10 may be described as a second query image 12 in multiple rounds.

The multiple cameras 2 may mean at least two or more cameras 2. Some of the multiple cameras 2 can record an object 1 from the same direction, but all of the multiple cameras 2 can record an object from various directions.

The cameras 1 can obtain a video by recording an object. The video can be divided into a plurality of frame images by being divided for each frame. A frame image may include at least one object image. An object image may be obtained from a frame image by an object recognition algorithm and/or an object recognition AI model. The object recognition AI model may be at least one of ab R-CNN, a Fast R-CNN, a Faster R-CNN, a YOLO, an SSD, and a RetinaNet, but is not limited thereto.

The object recognition algorithm or the object recognition AI model can obtain one or a plurality of objects 1 shown in a frame image as one or a plurality of object images.

The same object recognition method may include a step of obtaining an object image through an object recognition AI model. Unlikely, a separate device may obtain an object image.

The memory 120 can store videos obtained from multiple cameras 2 or one camera 1. The memory 120 can store a plurality of frame images. The memory 120 can store a plurality of object images. That is, the memory 120 can store data in at least one type of a video, a frame image, and an object image. In this case, a gallery image 20 or gallery images 20 may mean a plurality of object images stored in the memory 120.

A query image 10 may be one of gallery images 20. A query image 10 may be an image selected from gallery images 20 by a user. Alternatively, a query image 10 may be an image that is input by a user who is not included in gallery images 20.

Next, the comparing step (S1200) of determining similarity by comparing a query image 10 with gallery images 20 may be performed. The comparing step (S1200) may include a calculation step of obtaining distance values between a feature value of a query image 10 and feature values of gallery images 20, and a determination step of obtaining similarity of the gallery images 20 on the basis of the distance values. The feature value may be a vector value.

The comparing step (S1200) may be performed in accordance with an instruction from the controller 110 and may be performed by the similarity determiner 152 of the object search model 150.

The similarity determiner 152 can obtain a feature value by extracting a feature of a query image 10. The similarity determiner 152 can obtain feature values by extracting features of gallery images 20. In this case, the memory 120 can store the feature values of the query image 10 and/or the gallery images.

Unlikely, the similarity determiner 152 can use previously obtained feature values of a query image 10 and/or gallery images. In this case, the memory 120 can store in advance the feature values of the query image 10 and/or the gallery images.

The similarity determiner 152 can obtain distance values between a feature value of the query image 10 and feature values of gallery images 20. The similarity determiner 152 can obtain each distance value by comparing a query image 10 with each gallery image 20.

The similarity determiner 152 can obtain similarity of gallery images 20 on the basis of distance values. The larger the distance value, the lower the similarity may be determined, and the smaller the distance value, the higher the similarity may be determined.

Next, the ranking step (S1300) of obtaining some of gallery images 20 as rank images 30 on the basis of similarity may be performed. The ranking step (S1300) may include a step of obtaining rank images 30 in order of high similarity.

The ranking step (S1300) may be performed in accordance with an instruction from the controller 110 and may be performed by the rank obtainer 153 of the object search model 150.

The rank obtainer 153 can obtain rank images 30 by arranging some of gallery images 20 in accordance with similarity. Rank images 30 may mean images obtained by arranging gallery images 20 in order of high or low similarity.

Rank images 30 may be images obtained by arranging all of gallery images 20 or may be images obtained by arranging some of gallery images 20.

When a distance value is smaller than a minimum threshold value, similarity is excessively high and a query image 10 and a gallery image 20 may be images of the same object recorded from the same direction, so the gallery image 20 may be excluded from rank images 30.

When a distance value is larger than a maximum threshold value, similarity is excessively low and a query image 10 and a gallery image 20 may be images of different objects 1, so the gallery image 20 may be excluded from rank images.

Next, the rank recommendation step (S1400) of obtaining at least one of rank images 30 as a recommendation image 40 may be performed. The recommendation step (S1400) may include a step of providing rank images 30 to a user and a step of obtaining at least one of the rank images 30 selected by the user as a recommendation image 40.

The recommendation step (S1400) may be performed in accordance with an instruction from the controller 110 and may be performed by the rank recommender 154 of the object search model 150.

The rank recommender 154 can provide rank images 30 to a user. In this case, the output unit 140 can visually or aurally provide rank images 30 to a user. That is, the rank recommender 154 can provide some of gallery images 20 to a user in order of high similarity or low similarity to a query image 10. Accordingly, a user can select at least one of provided rank images 30 as a recommendation image 40.

The rank recommender 154 can obtain at least one of rank images 30 selected by a user as a recommendation image 40. Preferably, a recommendation image 40 may be an image that is an image of the same object 1 as a query image 10 (or a first query image 11) and is taken from another direction. A recommendation image 40 may be a subject of which the similarity to gallery images 20 is determined again, as a query image 10 (or a second query image 12).

In various embodiments, the rank recommendation step (S1400) of obtaining at least one of rank images 30 as a recommendation image 40 may be performed without the step of selection by a user. For example, the controller 110 can obtain the highest ranked image of rank images 30 as a recommendation image 40.

In this case, the recommendation image 40 is an image of the same object as a query image 10, but is not the same image because it does have the same figure, shape, and color. For example, when a query image 10 is an image of the back of a specific person, a recommendation image 40 may be an image of a side or the front of the same person.

The same object search method can repeatedly perform the comparing step (S1200), the ranking step (S1300), and the rank recommendation step (S1400) predetermined number of times (N times) using at least one recommendation image 40 as a query image 10.

In this case, the predetermined number of times (N times) may be a specific value set by a user or a system designer. Alternatively, the predetermined number of times (N times) may be value repeated until the distance between the first query image and the last recommendation image becomes larger than a predetermined threshold value.

According to the same object search method, all of the obtaining step (S1100), the comparing step (S1200), the ranking step (S1300), and the rank recommendation step (S1400) may be performed in the initial round, and only the comparing step (S1200), the ranking step (S1300), and the rank recommendation step (S1400) may be performed in multiple rounds.

A recommendation image 40 obtained in the rank recommendation step (S1400) in the initial round can be used as a query image 10 in the comparing step (S1200) in multiple rounds. For example, a recommendation image 40 obtained in the rank recommendation step (S1400) in the (n−1)-th round can be used as a query image 10 in the comparing step (S1200) in the n-th round.

A user or the controller 110 can select at least one of rank images 30 as a recommendation image 40 and the object search model 150 can search for similar gallery images 20 from a query image 10 using the recommendation image 40 again as the query image 10.

For example, referring to FIG. 4, in the initial round, a user can initially select a first query image 11 (the back of an object 1). The similarity determiner 152 can determine similarity between the first query image 11 (the back of the object 1) and gallery images 20. The rank obtainer 153 can obtain rank images 30 by arranging the gallery images 20 in accordance with similarity. The user or the controller 110 can select again a first recommendation image 41 (a side of the object 1). The rank recommender 154 can obtain a first recommendation image 41 in accordance with selection by the user or the controller 110. The first recommendation image 41 can be used again as a second query image 12 (the side of the object 1).

Next, the similarity determiner 152 can determine similarity between the second query image 12 (the side of the object 1) and gallery images 20. The rank obtainer 153 can obtain rank images 30 by arranging the gallery images 20 in accordance with similarity. The user or the controller 110 can select again a second recommendation image 42 (the front of the object 1). The rank recommender 154 can obtain a second recommendation image 42 in accordance with selection by the user or the controller 110. The second recommendation image 42 can be used again as a third query image 13 (the front of the object 1). Accordingly, the same object search method can search for the desired same object recorded from different 1 directions.

Referring to FIG. 3A again, yellow occupies a large proportion in the front of an object 1 and red occupies a large portion in the back of the object 1, so the similarity of the front and the back may be relatively low. Further, yellow occupies a large proportion in the front of the object 1 and, though not shown, yellow and red occupy similar proportions in the sides of the object 1, so the similarity of the front and the sides may be relatively high. Accordingly, the same object search method can finally search for an image of the back by obtaining images in order of the front and the sides of a query image 10 and comparing the images with gallery images 20.

A first query image (11, the back of an object) and a second recommendation image (42, the front of the object) are completely different in figure, shape, color, etc. because the colors of the clothing of the person are definitely different or the person wears accessories such as a bag, so the objects are difficult to be recognized as the same object at once. However, since a first recommendation image (41, a side of an object) is obtained using a first query image (11, the back of the object) and a second recommendation image (42, the front of the object) is obtained again using the first recommendation image (41, a side of the object) as a second query image 12, the first query image 11 and the second query image 42 can be searched for as images of the same object.

When videos are obtained from multiple cameras 2, it is possible to search for an image of an object 1 in another desired direction from an image of the object 1 in one direction while more delicately re-obtaining a query image 10 in comparison to the case described above.

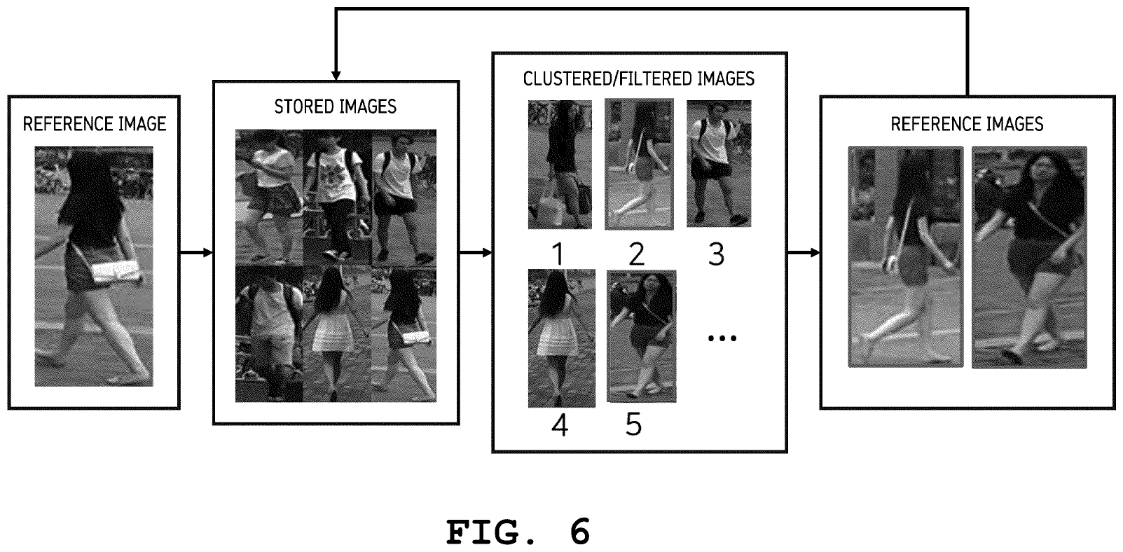

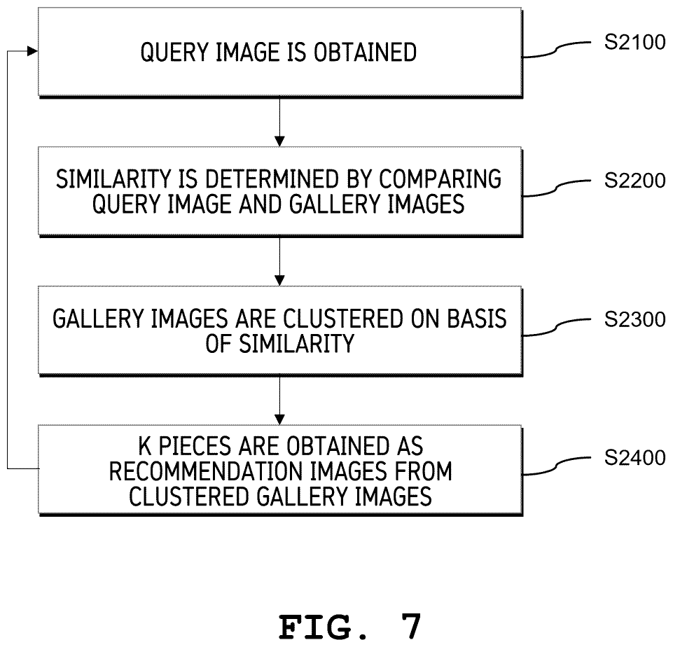

Referring to FIG. 6 and FIG. 7, the same object search method may include: an obtaining step of obtaining a query image 10 (S2100); a comparing step of determining similarity by comparing the query image 10 and gallery images 20 (S2200); a clustering step of clustering the gallery images 20 on the basis of the similarity (S2300); and a cluster recommendation step of obtaining k pieces from the clustered gallery images 21 as recommendation images 40 (S2400). The same object search method can repeatedly perform the comparing step (S2200), the clustering step (S2300), and the cluster recommendation step (S2400) using k recommendation images 40 as query images 10.

First, the obtaining step (S2100) of obtaining a query image 10 may be performed.

The obtaining step (S2100) may be performed in accordance with an instruction from the controller 110 and may be performed by the query obtainer 151 of the object search model 150. In detail, the obtaining step (S2100) is the same as the obtaining step (S1100) described above, so it not described.

Next, the comparing step (S2200) of determining similarity by comparing a query image 10 with gallery images 20 may be performed.

The comparing step (S2200) may be performed in accordance with an instruction from the controller 110 and may be performed by the similarity determiner 152 of the object search model 150. In detail, the comparing step (S2200) is the same as the comparing step (S1200) described above, so it will not be described.

Next, the clustering step (2300) of clustering gallery images 20 on the basis of similarity may be performed.

The clustering step (2300) may be performed in accordance with an instruction from the controller 110 and may be performed by the clusterer 153 of the object search model 150.

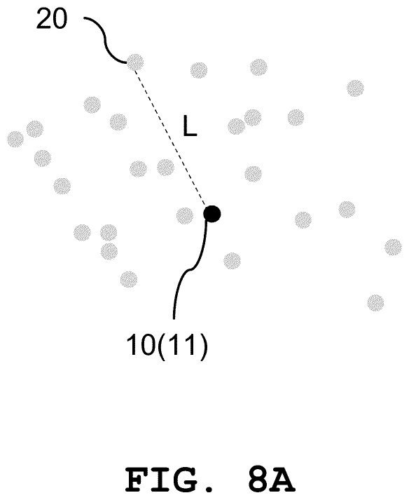

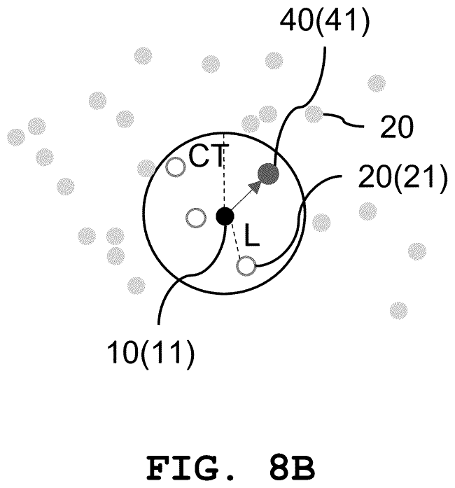

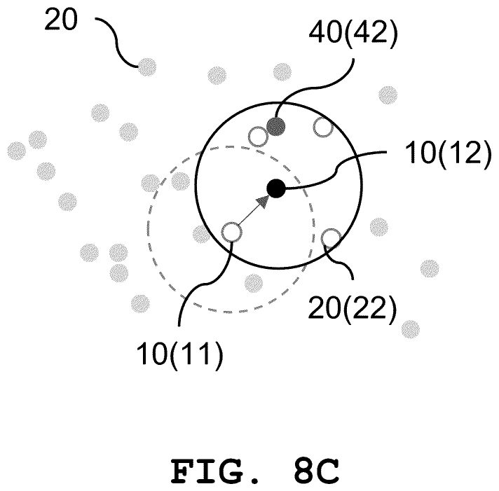

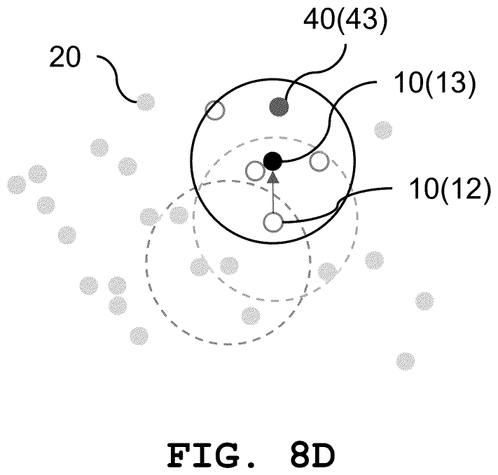

Referring to FIGS. 8A and 8B, the clusterer 153 can cluster at least some of gallery images 20 in accordance with similarity. Similarity can be determined on the basis of distance values between a feature value of a query image 10 and feature values of gallery images 20 in the comparison step (S2200).

The clusterer 153 can cluster gallery images 20 having a distance value L smaller than a cluster threshold CT. In detail, it is possible to cluster all gallery images 20 having a distance value L smaller than a cluster threshold CT.

There may be a plurality of query images 10.

When a plurality of query images 10 is obtained, it is possible to determine similarity on the basis of the distance value between the feature value of each of the query images 10 and the feature values of gallery images 20 in the comparing step.

When a plurality of query images 10 is obtained, the clusterer 153 can cluster gallery images 20 having a distance value L smaller than a cluster threshold CT. In detail, it is possible to cluster all gallery images 20 of which the distance value L from each of the query images 10 is smaller than a cluster threshold CT. In this case, since there is a plurality of query images 10, the clusterer 153 can obtain a plurality of clusters by clustering gallery images 20 on the basis of each of the query images 10.

For example, the clusterer 153 can cluster gallery images 20 of the front and the sides of an object 1 that have high similarity on the basis of a query image 10 corresponding to the front of the object 1. For example, the clusterer 153 can exclude gallery images 20 of the back of an object 1 that have low similarity from the targets of clustering on the basis of a query image 10 corresponding to the front of the object 1.

Referring to FIG. 8A, a first query image 11 can be selected from gallery images 20 or input as an external image by a user. The similarity determiner 152 can determine similarity by calculating the distance values L between the first query image 11 and gallery images 20.

Referring to FIG. 8B, a cluster threshold CT can be selected by a user or randomly in advance. The clusterer 153 can obtain a cluster by clustering gallery images 20 of which the calculated distance values L are smaller than the cluster threshold CT.

Next, the cluster recommendation step (S2400) of obtaining k pieces from clustered gallery images 21 as recommendation images 40 may be performed. The cluster recommendation step (S2400) may include a step of filtering out clustered gallery images 21 in accordance with preset conditions and a step of obtaining k pieces from the filtered gallery images 22 as recommendation images 40.

The cluster recommendation step (S2400) may be performed in accordance with an instruction from the controller 110 and may be performed by the cluster recommender 154 of the object search model 150.

The cluster recommender 154 can obtain k recommendation images 40 from clustered gallery images 21. The cluster recommender can filter out clustered gallery images 21 in accordance with preset conditions. The filtering may refer to selecting only gallery images 20 that meet preset conditions. Filtered gallery images 22 may mean gallery images 20 that meet preset conditions.

The preset conditions may include a first condition in which the distance values L between the feature value of a query image 10 and the feature values of gallery images 20 are larger than a minimum threshold and/or a second condition in which the distance values L between the feature value of a query image 10 and the feature values of gallery images 20 are smaller than a maximum threshold. The minimum threshold may be smaller than the maximum threshold. For example, when a distance value is 2D data, a minimum threshold and a maximum threshold set the radius of a cluster.

A minimum threshold may be set by a user or randomly in advance. When a distance value L is smaller than a minimum threshold, it shows a very similar state, so a recommendation image 40 may be an image very similar to a first query image 11. For example, when a first query image 11 is a front image of an object 1, a recommendation image 40 may also be a front image of the object 1, so more repeated execution is required to search for the back of the object 1, and accordingly, the search time may be delayed.

A maximum threshold may be set by a user or randomly in advance. When a distance value L is larger than a maximum threshold, it shows a very dissimilar state, so a recommendation image 40 may be an image very dissimilar to a first query image 11. For example, when a first query image 11 is a front image of an object 1, a recommendation image 40 may be an image of another object 1, so confusion may be caused until the back of the object 1 is searched, and accordingly, time may be delayed.

The cluster recommender 154 re-obtains gallery images 20 that are not very similar to and are not very dissimilar to a query image 10 on the basis of preset conditions, thereby being able to reduce the time for searching for the same object 1.

The cluster recommender 154 can obtain k recommendation images 40 from filtered gallery images 22. In this case, k may be a singular number or a plural number.

The cluster recommender 154 can obtain k recommendation images 40 in order of small distance value L between the feature value of a query image 10 and the feature values of gallery images 20 from filtered gallery images 22.

The cluster recommender 154 can obtain k recommendation images 40 in order of large distance value L between the feature value of a query image 10 and the feature values of gallery images 20 from filtered gallery images 22.

The cluster recommender 154 can randomly obtain k pieces as recommendation images 40 from filtered gallery images 22.

Referring to FIG. 8B, the clusterer 153 can obtain a cluster by clustering gallery images 20 of which the calculated distance values L are smaller than the cluster threshold CT. For example, the clusterer 153 can cluster four gallery images 20 on the basis of a first query image 11. The cluster recommender 154 can obtain one recommendation image 40 from clustered gallery images 21 or filtered gallery images 22. For example, the cluster recommender 154 can obtain one of the other gallery images 20 as a first recommendation image 41 by filtering out (excluding) the outermost and the innermost gallery images 20 from a first query image 11.

Referring to FIG. 8C, the first recommendation image 41 can be used as a second query image 12. The clusterer 153 can cluster five gallery images 20 on the basis of the second query image 12. The cluster recommender 154 can obtain one recommendation image 40 from clustered gallery images 21 or filtered gallery images 22. For example, the cluster recommender 154 can obtain one of the other gallery images 20 as a second recommendation image 42 by filtering out (excluding) some gallery images 20 on the basis of the second query image 12.

Referring to FIG. 8D, the second recommendation image 42 can be used as a third query image 13. The clusterer 153 can cluster five gallery images 20 on the basis of the third query image 13. For example, the cluster recommender 154 can obtain one of the other gallery images as a third recommendation image 43 by filtering out (excluding) some gallery images on the basis of the third query image 13.

The same object search method can repeatedly perform the comparing step (S2200), the clustering step (S2300), and the cluster recommendation step k (S2400) using recommendation images 40 as query images 10.

According to the same object search method, all of the obtaining step (S2100), the comparing step (S2200), the clustering step (S2300), and the cluster recommendation step (S2400) may be performed in the initial round, and only the comparing step (S2200), the clustering step (S2300), and the cluster recommendation step (S2400) may be performed in multiple rounds.

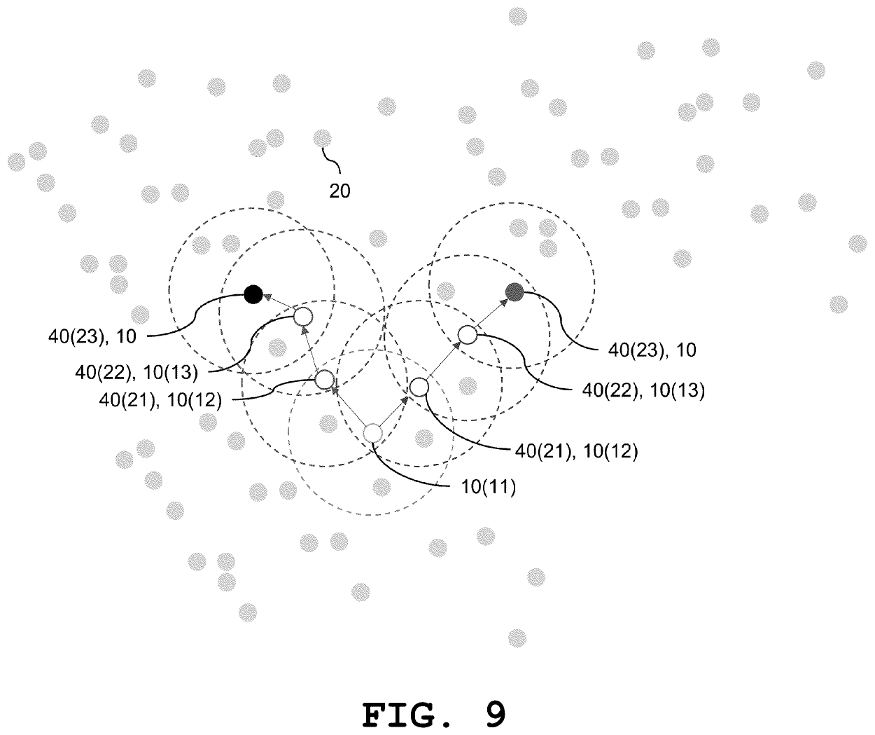

Referring to FIG. 9, the same object search method can perform the comparing step (S2200), the clustering step (S2300), and the cluster recommendation step (S2400) using k recommendation images 40 as query images 10.

A recommendation image 40 obtained in the cluster recommendation step in the initial round can be used as a query image 10 in the comparing step in the second round. For example, a recommendation image 40 obtained in the cluster recommendation step (S2400) in the (n−1)-th round can be used as a query image 10 in the comparing step (S2200) in the n-th round. In this case, when recommendation images 40 are 3 in first round, query images 10 may be k in multiple rounds.

The object search model 150 can select and obtain k recommendation images 40 from filtered gallery images 22 and can search for similar gallery images 20 from query images 10 by using the k recommendation images 40 again as k query images 10.

The similarity determiner 152 can determine similarity by calculating the distance values L between each of the k query images 10 and the gallery images 20.

The clusterer 153 can obtain k clusters by clustering gallery images 20 of which the calculated distance values L from each of the k query images 10 are smaller than a cluster threshold CT.

The cluster recommender 154 can obtain k recommendation images 40 from clustered gallery images 21 of the k clusters or filtered gallery images 22 of the k clusters.

The same object search method can more quickly search for a desired object 1 through repeated execution of a smaller number of times by searching for the same object 1 using k clusters.

Referring to FIG. 6, in the initial round, a user can initially select a query image 10 (the back of an object 1). The similarity determiner 152 can determine similarity between the query image 10 (the back of the object 1) and gallery images 20. The clusterer 153 can obtain a cluster by clustering the gallery images 20 in accordance with similarity. The cluster recommender 154 can select and obtain two recommendation images 40 (the right side and the left front side of the object 1) from clustered gallery images 21 or filtered gallery images 22. The two recommendation images 40 can be used again as query images 10 (the right side and the left front side of the object 1).

Next, the similarity determiner 152 can determine similarity between the two query images 10 (the right side and the left front side of the object 1) and the gallery images 20. The clusterer 153 can obtain two clusters by clustering the gallery images in accordance with similarity. The cluster recommender 154 can select and obtain two recommendation images 40 (the left side and the right front side of the object 1) from clustered gallery images 21 or filtered gallery images 22. The two recommendation images 40 can be used again as query images 10 (the left side and the right front side of the object 1). Accordingly, the same object search method can search for the desired same object 1 recorded from different directions.

Referring to FIG. 3B again, yellow occupies a large proportion in the front of an object 1 and gray occupies a large portion in the back of the object 1, so the similarity of the front and the back may be relatively low. Further, yellow occupies a large proportion in the front of the object 1 and, though not shown, yellow and gray occupy similar proportions in the sides of the object 1, so the similarity of the front and the sides may be relatively high. Accordingly, the same object search method can finally search for an image of the back by obtaining images in order of the front and the sides of a query image 10 and comparing the images with gallery images 20.

When videos are obtained from multiple cameras 2, the same object search method can search for an image of an object 1 in another desired direction from an image of the object 1 in one direction while more delicately re-obtaining a query image 10 in comparison to the case described above.

Further, the same object search method can quickly search for an image of an object 1 in another desired direction from an image of the object 1 in one direction using k query images 10, k clusters, and k recommendation images 40.

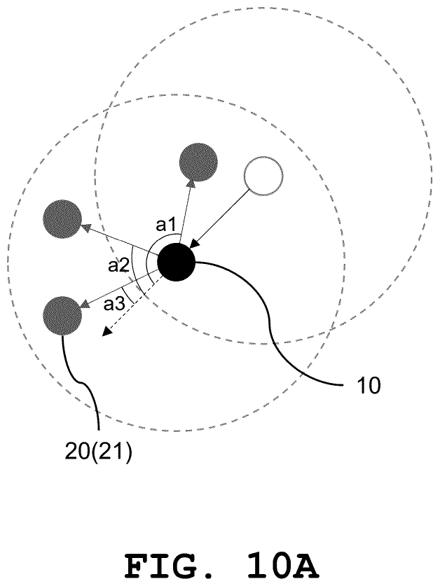

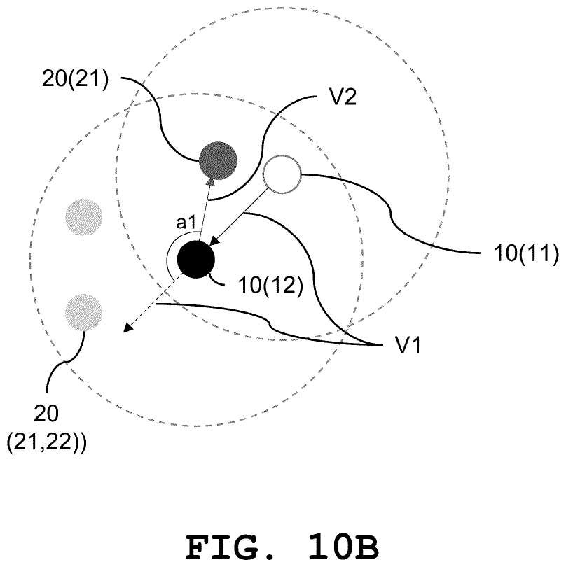

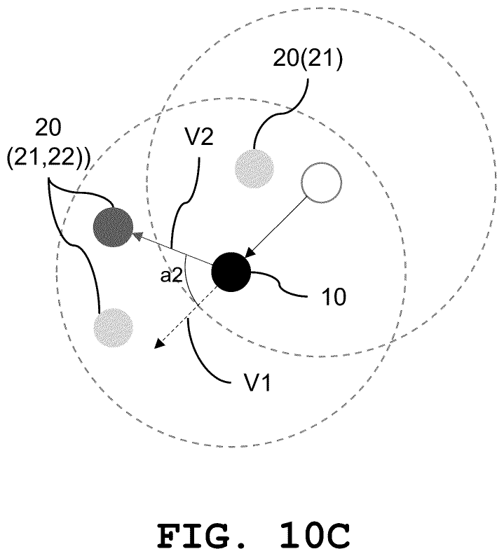

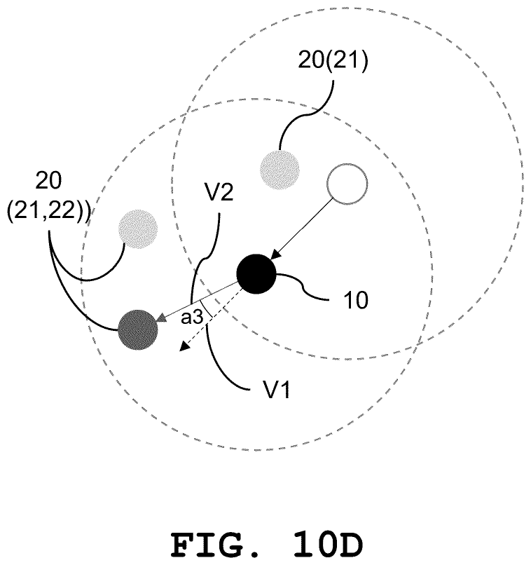

Referring to FIG. 10A, preset conditions in multiple rounds in an embodiment may include a third condition in which the contained angles between a first vector going to the feature value of an n-th query image 10 from the feature value of an (n−1)-th query image 10 and second vectors going to the feature values of gallery images 20 from the feature value of an n-th query image 10 (angles with the start points of the first vector and the second vectors coinciding with each other) are smaller than a maximum threshold angle.

Referring to FIG. 10B, when a maximum threshold value is set as 120 degrees, the contained angle a1 between a first vector V1 and a second vector V2 is larger than 120 degrees, so the corresponding gallery image can be excluded from filtered gallery images 22.

Referring to FIG. 10C, when a maximum threshold value is set as 120 degrees, the contained angle a2 between a first vector V1 and a second vector V2 is smaller than 120 degrees, so the corresponding gallery image can be included in filtered gallery images 22.

Referring to FIG. 10D, when a maximum threshold value is set as 120 degrees, the contained angle a3 between a first vector V1 and a second vector V2 is smaller than 120 degrees, so the corresponding gallery image can be included in filtered gallery images 22.

The same object search method can prevent the phenomenon that a query image 10 is searched only in a specific region and fixed in the specific region in repeated execution by excluding gallery images 20 having a contained angle larger than a maximum threshold angle. That is, the same object search method can quickly search for the same object 1 recorded from a desired direction by providing the movement directions of query images 10 in repeated execution

Referring to FIG. 10A, preset conditions in multiple rounds in an embodiment may include a fourth condition in which images are not (n−1)-th clustered gallery images 20.

Referring to FIG. 10B to FIG. 10D, gallery images clustered on the basis of a first query image 11 can be excluded from filtered gallery images 22.

The same object search method can prevent the phenomenon that a query image 10 is fixed in a specific region in repeated execution by excluding gallery images 21 clustered on the basis of an (n−1)-th query image 10 from filtered gallery images 22. That is, the same object search method can quickly search for the same object recorded from a desired direction by providing the movement directions of query images 10 in repeated execution

Although the present disclosure was described through preferred embodiments, those skilled in the art may change or modify the present disclosure in various ways within a range not departing from the spirit and scope of the present disclosure described in the following claims.

What is claimed is:

1. A method of searching for the same object based on multi-camera images by using gallery images obtained through multiple cameras, the method comprising:
an obtaining step of obtaining a query image;
a comparing step of determining similarity by comparing the query image with the gallery images;
a ranking step of obtaining some of the gallery images as rank images on the basis of the similarity; and
a rank recommendation step of obtaining at least one of the rank images as a recommendation image,
wherein the method repeatedly performs the comparing step, the ranking step, and the rank recommendation step using the at least one recommendation image as the query image.

2. The method of claim 1, wherein the comparing step comprises:
a calculation step of obtaining distance values between a feature value of a query image and feature values of the gallery images; and
a determination step of obtaining similarity of the gallery images on the basis of the distance values.

3. The method of claim 1, wherein the ranking step comprises obtaining the rank images in order of high similarity.

4. The method of claim 1, wherein the rank recommendation step comprises:
providing the rank images to a user; and
obtaining at least one of the rank images selected by the user as the recommendation image.

5. The method of claim 1, wherein the query image in the comparing step and the recommendation image in the rank recommendation step are images of the same object recorded through different cameras or recorded from different directions through one camera.

6. A method of searching for the same object based on multi-camera images by using gallery images obtained through multiple cameras, the method comprising:
an obtaining step of obtaining a query image;
a comparing step of determining similarity by comparing the query image with the gallery images;
a clustering step of clustering the gallery images on the basis of the similarity; and
a cluster recommendation step of obtaining k pieces from the clustered gallery images as recommendation images,
wherein the method repeatedly performs the comparing step, the clustering step, and the cluster recommendation step using the k recommendation images as the query images.

7. The method of claim 6, wherein the cluster recommendation step comprises:
filtering out the clustered gallery images in accordance with preset conditions; and
obtaining k pieces from the filtered gallery images as recommendation images.

8. The method of claim 7, wherein the preset conditions comprise a first condition in which distance values between a feature value of the query image and feature values of the gallery images are larger than a minimum threshold.

9. The method of claim 8, wherein the preset conditions comprise a second condition in which the distance values are smaller than a maximum threshold.

10. The method of claim 7, wherein the obtaining of k pieces as recommendation images obtains the k pieces as the recommendation images from the filtered gallery images in order of small distance value between a feature value of the query image and feature values of the gallery images.

11. An apparatus for searching for the same object based on multi-camera images that is operated by an object search model in accordance with an instruction from a controller,
wherein the object search model
performs an obtaining step of obtaining a query image, a comparing step of determining similarity by comparing the query image with the gallery images, a ranking step of obtaining some of the gallery images as rank images on the basis of the similarity, and a rank recommendation step of obtaining at least one of the rank images as a recommendation image, and
repeatedly performs the comparing step, the ranking step, and the rank recommendation step using the at least one recommendation image as the query image.

12. A computer-readable recording medium on which a program for performing the method of claim 1 or claim 6 is recorded.
